(19) United States
(12) Patent Application Publication
(10) Pub. No.: US 2022/0212937 A1
(43) Pub. Date: Jul. 7, 2022

(54) METHOD FOR REFINING CRUDE SILICON MELTS USING A PARTICULATE MEDIATOR

(71) Applicant: Wacker Chemie AG, Munich (DE)

(72) Inventors: Karl-Heinz Rimböck, Heldenstein (DE); Konrad Mautner, Burghausen (DE)

(73) Assignee: Wacker Chemie AG, Munich (DE)

(21) Appl. No.: 17/608,037

(22) PCT Filed: Apr. 30, 2019
(86) PCT No.: PCT/EP2019/061031

§ 371 Date: Nov. 1, 2021

(51) Int. Cl. C01B 33/037

(52) U.S. Cl. CPC C01B 33/037; C01P 2004/60

(57) ABSTRACT

A process for the oxidative refining of crude silicon melts during the production of technical-grade silicon. The process includes oxidative refining a crude silicon melt during the production of technical-grade silicon, where during the refining of the crude silicon melt, a finely divided mediator having a particle size parameter d₅₀ of 1 to 200 μm is added. The finely divided mediator contains a minimum content of metallic silicon of 8% by mass and also at least one or more of the elements H, C, O, F, Cl, Ca, Fe and Al. Additionally, the finely divided mediator is added to the crude silicon melt by means of pneumatic conveying with a gas.

The invention relates to a process for the oxidative refining of crude silicon melt during the production of technical-grade silicon by addition of a finely divided mediator to the crude silicon melt by means of pneumatic conveying.

Silicon is used nowadays in technical grade (technical-grade silicon) in particular in silicothermic processes, in metal extraction, as a deoxidizer in steel production, and serves as an alloying constituent for cast alloys of aluminum, copper, titanium and iron, and also as a starting material for chemical compounds.

Industrially, technical-grade silicon is produced by the carbothermic reduction of quartz (SiO₂; optionally further additives such as for example Fe-containing waste materials [ferrosilicon] or calcium carbide [calcium silicon]) at high temperatures (around 2000° C.) and atmospheric pressure in an electric furnace (arc reduction furnace) according to net reaction equation (1). The process is described in detail in the standard work “Production of High Silicon Alloys” (A. Schei, J. K. Tuset, H. Tveit, Production of High Silicon Alloys, 1998, Tapir forlag, Trondheim).

SiO₂+2C→Si(l)+2CO(g) (1)

During operation the reactants, intermediates and products are present in different states of matter: solid (C, SiC, SiO₂, Si), liquid (Si, SiO₂) and gaseous (predominantly CO, SiO). The carbon source used is typically a reduction mixture composed of coke, petroleum coke, bituminous coal, charcoal and wood particles. A strongly reducing atmosphere composed in particular of SiO and CO prevails in the furnace. During operation SiO₂ and C move downwards while SiO and CO flow upwards. Intermediate species are formed according to the following reaction equations (2)-(7):

SiO₂+C→SiO+CO (2)

SiO+2C→SiC+CO (3)

SiO₂₊₂SiC→3Si+2CO (4)

2SiO₂+SiC→3SiO+CO (5)

SiO₂+CO→SiO+CO₂ (6)

2CO₂+SiC→SiO+3CO (7)

Silicon is predominantly formed by the reaction shown in reaction (8).

SiO+SiC→2Si+CO (8)

Such high-temperature processes necessitate a mode of operation which is as continuous as possible. Both the raw materials and the liquid crude silicon are respectively fed in and discharged at intervals. The latter is typically performed by tapping the furnace and subsequently transferring the liquid crude silicon (having a temperature of approximately 1600 to 1900° C.) into a treatment vessel.

In addition to the economic aspects of an industrial process (for example productivity, production costs), the quality of the product produced is also of critical importance. When using metallurgical-grade silicon in the production of chemical compounds, for example chlorosilanes, impurities present in the silicon (for example boron in the form of volatile chlorides) are partially—and despite interposed purification steps—carried over into the respective end products (e.g. polycrystalline silicon, silicones) in the course of a plurality of process steps. Depending on the field of use, however, these end products have to satisfy extremely high quality requirements (semiconductor/pharmaceuticals/foodstuffs/cosmetics industries). For the production of these products on an industrial scale, a high-quality starting material—metallurgical-grade silicon—is therefore important.

The raw materials and electrodes typically used in the carbothermic reduction of SiO₂ contain various impurities. The liquid crude silicon is typically oxidatively refined in the abovementioned treatment vessels, since at this point the crude product still contains up to 5% by mass of impurities. It is customary in the industry to refine crude silicon by means of treatment with a reactive gas mixture (for example Cl₂, O₂, SiCl₄, wet H₂ and CO₂, or combinations of these; typically diluted with an inert gas) and the addition of slag-forming additives (for example quartz sand, limestone, quicklime, dolomite, fluorspar, etc.), with a distribution equilibrium for the secondary elements being established between the silicon phase and slag phase. During the refining, the temperature of the refining mixture drops from approx. 1900° C. down to approx. 1500° C. In order to prevent the mixture from solidifying, a reagent which is gaseous under the operating conditions is added to the mixture—as described above. For example, supplying oxygen brings about the oxidation of silicon to silicon dioxide, with the energy released keeping the mixture situated in the treatment vessel liquid. The term “oxidative refining” encompasses the combination of supplying an oxygen-containing gas mixture and adding one or more slag-forming agents.

After the oxidative refining has ended, the silicon phase and slag phase of the usually still-liquid mixture are separated.

The greatest disadvantages in conventional oxidative refining methods are the loss of silicon via the slag in the form of silicon dioxide or metallic silicon trapped in the slag and also the inefficient removal of undesired secondary elements. This reduces both the economic viability of the silicon production and also the quality of the corresponding product.

The object of the present invention was that of improving the economic viability of the production of technical-grade silicon and also the efficiency of the removal of undesired secondary elements, and hence the quality of the product.

The invention provides a process for the oxidative refining of crude silicon melt during the production of technical-grade silicon, in which during the refining the crude silicon melt has added to it a finely divided mediator having a particle size parameter d₅₀ of 1 to 200 μm, this mediator containing a minimum content of metallic silicon of 8% by mass and also at least one or more of the elements H, C, O, F, Cl, Ca, Fe and Al,

wherein the finely divided mediator is added to the crude silicon melt by means of pneumatic conveying with a gas.

Surprisingly, it has been found that adding the finely divided mediator during the refining of crude silicon melts makes it possible to increase the productivity of the production of technical-grade silicon and also the quality of the technical-grade silicon. The reasons for this are firstly the reduction of silicon losses via a more efficient phase separation between silicon and slag, and secondly the more efficient removal of undesired accompanying elements. The former thus leads to higher yields of technical-grade silicon and hence to a lower specific energy consumption for the production of technical-grade silicon. A further advantage of the process according to the invention consists in the possibility of making use of or recycling by-products and wastes within the context of a circular economy.

The crude silicon melts are preferably produced by carbothermic reduction of quartz with carbon in an electric furnace.

The crude silicon melt is preferably oxidatively refined by treatment with a reactive gas mixture which preferably contains compounds selected from Cl₂, O₂, SiCl₄, wet H₂ and CO₂, and combinations of these. The reactive gas mixture is preferably diluted with an inert gas selected from nitrogen and argon and combinations thereof. A particularly preferred refining gas is an oxygen-containing gas mixture which may be diluted with an inert gas and optionally humidified.

The mediator is preferably added to the crude silicon melt, i.e. into the treatment vessel containing the crude silicon melt, by means of a lance. The gas used to pneumatically convey the mediator can be a pure gas or a gas mixture. Preference is given to using, for the pneumatic conveying of the mediator, a portion of or the entire reactive gas mixture which is used for the oxidative refining.

The process according to the invention thus increases the economic viability of the production process for technical-grade silicon and also the quality of the product compared to conventional processes.

Technical-grade silicon has an Si content of <99.9% by mass based on the total weight of the technical-grade silicon. The accompanying elements are usually selected from Fe, Ca, Al, Ti, Cu, Mn, Cr, V, Ni, Mg, Co, W, Mo, As, Sb, Bi, S, Se, Te, Zr, Ge, Sn, Pb, Zn, Cd, Sr, Ba, Y, B, C, P and O.

The Si content is determined as follows: 100% by mass minus the proportions by weight of the accompanying elements.

Significant types of technical-grade silicon which are refined in the process are calcium silicon (calcium disilicide, CaSi₂) comprising 55-65% by mass of Si and 35-45% by mass of Ca, ferrosilicon comprising 45-90% by mass of Si and 10-55% by mass of Fe and metallurgical-grade silicon comprising 98-99.5% by mass of Si.

The technical-grade silicon produced preferably has an Si content of at least 90% by mass, particularly preferably at least 95% by mass, and in particular at least 97% by mass.

The mediator is preferably used as a particle mixture. The particles of the mediator preferably have a particle size parameter d₅₀ of 1 to 200 μm, particularly preferably of 5 to 150 μm, very particularly preferably of 10 to 100 μm, in particular of 15 to 75 μm.

The mediator is added, during the oxidative refining of crude silicon melt, to the crude silicon melt in addition to or instead of the conventional slag-forming additives. Slag-forming additives are preferably selected from quartz sand, limestone, quicklime, dolomite, and fluorspar.

In a preferred embodiment, the proportion by weight of reactive carbon in the mediator, based on the total mass of the mediator, is not more than 0.1, preferably not more than 0.08, particularly preferably not more than 0.06, and in particular not more than 0.04. In the present invention, “reactive carbon” should be understood as meaning the proportion of carbon in the mediator which reacts with O₂ by thermo-oxidative degradation up to a temperature of 1100° C. Reactive carbon is typically carbon in organic compounds (e.g. oils, fats, polymers) and also carbon in inorganic compounds (e.g. carbonates, carbides) and elemental carbon in its allotropic forms.

According to a preferred embodiment, the mediator has a water content of at most 5% by mass, preferably of at most 3% by mass, particularly preferably of at most 1% by mass, and in particular of at most 1000 ppmw. According to a preferred embodiment, the mediator has a proportion by weight of oxygen of at most 0.4, preferably at most 0.3, particularly preferably at most 0.2, in particular at most 0.15, but at least 0.01.

The minimum content of metallic silicon in the mediator in the dry state is preferably 10% by mass, particularly preferably at least 20% by mass, very particularly preferably at least 30% by mass, and in particular at least 40% by mass.

The mediator preferably contains silicon residues which are preferably selected from by-products or wastes from the silicon producing or processing industries, for example
those arising during the production or during the mechanical processing of silicon, such as polycrystalline, multicrystalline or monocrystalline silicon, the mechanical processing in particular being crushing, grinding and/or sawing;
those arising in the production of granulated silicon metal, for example in fluidized bed, centrifugal, gas atomization and water granulation processes;
those arising in the production of technical-grade silicon by means of carbothermic reduction of SiO₂;
those arising in the mechanical processing and optionally one or more classifying processes of technical-grade silicon. The mechanical processing may in particular be crushing and/or grinding. Typical classifying processes are for example sieving and/or sifting;
those arising in the production of silanes. These may be for example neutralized catalyst material from chlorosilane reactors, before and/or after a recovery of Cu; in particular from Müller-Rochow direct synthesis processes, hydrochlorination or low-temperature conversion of silanes.

Purification of these silicon residues prior to use according to the invention in the mediators is usually not necessary.

The mediator preferably contains at least 10% by mass of silicon residues, particularly preferably at least 20% by mass, very particularly preferably at least 30% by mass, in particular at least 50% by mass of silicon residues.

The mediator is preferably subjected to a comminution (e.g. grinding, crushing), classifying (e.g. sieving, sifting) and/or agglomeration process (e.g. pelletizing, briquetting, sintering) in order to obtain the desired value for particle size parameter d₅₀.

The total porosity of a substance is made up of the sum total of the voids connected to one another and to the environment (open porosity; here in the present invention referred to as effective porosity) and the voids not connected to one other (closed porosity). Porosity measurements are carried out in accordance with Archimedes' principle according to ASTM C373-88. The porosity of a material may also be carried out by calculation from the absolute and the apparent density. Absolute and apparent density may be determined by means of weight measurement and volume measurement by gas pycnometers. The density determination of solids is described in DIN 66137-2:2019-03.

The mediator preferably has an average effective porosity of not more than 0.5, particularly preferably of not more than 0.4, in particular of not more than 0.3.

The elements present in addition to the metallic silicon in the mediator can be present as compounds or alloys of these elements.

In addition to the elements already described, the particulate mediator may contain the following accompanying elements: Si, Li, Na, K, Mg, Ca, Ba, Ti, Zr, V, Cr, Mo, W, Mn, Fe, Co, Ni, Cu, Zn, B, Sn, Pb, N, P, As, Sb, Bi, S.

Preferably, the mass ratio of mass (mediator) to mass (crude silicon melt) when adding the mediator is 0.01 to 0.15, particularly preferably 0.02 to 0.12, very particularly preferably 0.03 to 0.10, in particular 0.04 to 0.09.

After the oxidative refining has ended, the technical-grade silicon and slag phases of the usually still-liquid mixture are separated and the liquid technical-grade silicon is solidified on a cooled surface or in a cooled medium. This can be done, for example, by decanting the mixture, casting the floating technical-grade silicon phase into a trough and solidifying the technical-grade silicon in said trough.

It may additionally be preferable to dope or to alloy the liquid technical-grade silicon with elements in a controlled manner. This may be advisable, for example, when the technical-grade silicon to be produced is intended for use in the synthesis of chlorosilanes. This involves one or more of the elements from the group comprising Al, Cu, Sn, Zn, O and P, or a compound or a plurality of compounds of these elements, or mixtures of these elements and compounds.

The determination of the silicon content of the mediator can for example be carried out via X-ray fluorescence analysis (XFA), ICP-based analysis methods (ICP-MS, ICP-OES) or atomic absorption spectroscopy (AAS).

Particle size distributions can be determined in accordance with ISO 13320 (laser diffraction) and/or ISO 13322 (image analysis). Average particle sizes/diameters can be calculated from particle size distributions in accordance with DIN ISO 9276-2.

The proportion of “reactive carbon” and the water content in the mediator are preferably determined using a multiphase analyzer such as a LECO RC-612 instrument (cf. also DIN 19539).

### EXAMPLES

Liquid crude silicon from a continuous production process for metallurgical-grade silicon was collected in a treatment vessel and then, with the addition of various mediators (having a particle size parameter d₅₀ of 25 μm; addition by pneumatic conveying with air via a refractory injection lance directly into the liquid crude silicon), was oxidatively refined over a period of 100 min (refining gas: oxygen/air mixture [oxygen content at 30% by volume based on the total volume of the gas mixture]; volume flow rate of the mixture: 16 Nm³/h per 1 t of liquid crude silicon), and the silicon phase was decanted into a trough and finally solidified. After cooling down to room temperature and mechanically removing the silicon from the trough, the specific energy consumption per ton of silicon product and the purity of the silicon product were determined. The tests were evaluated by comparison with conventional processes: usually, the specific energy consumption per ton of silicon product is 13.0 MWh/t, with the purity of the silicon product being approx. 98.5%. Table 1 gives an overview of the mediators used—the results of the tests are summarized in Table 2.

TABLE 1

| | Si [% by | Accompanying | Content [% by mass] | | |
|---|---|---|---|---|---|
| Mediator | mass] | elements | Water | O | C |
| A | 10 | Fe, Ca, Al, F, Cl | 1 | 35 | 7 |
| B | 10 | Fe, Ca, Al, F, Cl | 0.05 | 0.5 | 5 |
| C | 10 | Fe, Ca, Al, F | 0.1 | 5 | 2 |
| D | 10 | Fe, Ca, Al | 0.1 | 5 | 1.5 |
| E | 10 | Fe, Ca, Al | 0.1 | 15 | 1.5 |
| F | 20 | Fe, Ca, Al | 0.1 | 5 | 1.5 |
| G | 40 | Fe, Ca, Al | 0.1 | 5 | 1.5 |
| H | 50 | Fe, Ca, Al | 0.1 | 5 | 1.5 |
| I | 60 | Fe, Ca, Al | 0.1 | 5 | 1.5 |
| J | 80 | Fe, Ca, Al | 0.1 | 5 | 1.5 |

TABLE 2

| | | Mass ratio | Specific energy | Purity |
|---|---|---|---|---|
| | | m(mediator)/ | consumption | [% by mass |
| Test | Mediator | m(crude silicon) | [MWh/t] | of Si] |
| 1 | A | 0.07 | 12.92 | 98.8 |
| 2 | B | 0.07 | 12.91 | 98.8 |
| 3 | C | 0.07 | 12.91 | 98.7 |
| 4 | D | 0.07 | 12.9 | 98.8 |
| 5 | E | 0.07 | 12.9 | 98.8 |
| 6 | F | 0.07 | 12.85 | 98.9 |
| 7 | G | 0.07 | 12.87 | 98.8 |
| 8 | H | 0.07 | 12.8 | 98.9 |
| 9 | I | 0.07 | 12.78 | 98.9 |

1-9. (canceled)

10. A process for the oxidative refining of crude silicon melt, comprising:
oxidative refining a crude silicon melt during the production of technical-grade silicon, wherein during the refining of the crude silicon melt a finely divided mediator having a particle size parameter d₅₀ of 1 to 200 μm is added, wherein the finely divided mediator contains a minimum content of metallic silicon of 8% by mass and also at least one or more of the elements H, C, O, F, Cl, Ca, Fe and Al, wherein the finely divided mediator is added to the crude silicon melt by means of pneumatic conveying with a gas.

11. The process of claim 10, wherein the technical-grade silicon has an Si content of at least 95% by mass.

12. The process of claim 10, wherein the finely divided mediator contains silicon residues which are selected from by-products or wastes arising in the production or in the mechanical processing of silicon.

13. The process of claim 10, wherein the finely divided mediator is added to the crude silicon melt by means of a lance.

14. The process of claim 10, wherein the gas with which the finely divided mediator is added to the crude silicon melt contains constituents selected from Cl₂, O₂, SiCl₄, wet H₂ and CO₂, and combinations of these.

15. The process of claim 10, wherein the finely divided mediator has a proportion by weight of oxygen of at most 0.4% by mass.

16. The process of claim 10, wherein the finely divided mediator has a water content of at most 5% by mass.

17. The process of claim 10, wherein the proportion by weight of reactive carbon in the finely divided mediator, based on the total mass of the finely divided mediator, is not more than 0.1, wherein reactive carbon is the proportion of carbon in the finely divided mediator which reacts with O₂ by thermo-oxidative degradation up to a temperature of 1100° C.

18. The process of claim 10, wherein the mass ratio of mass (finely divided mediator) to mass (crude silicon melt) when adding the finely divided mediator is 0.01 to 0.15.
